(19) United States
(12) Patent Application Publication
(10) Pub. No.: US 2012/0056428 A1
(43) Pub. Date: Mar. 8, 2012

(54) VEHICLE WIND TURBINE

(75) Inventors: Paul Robert Bennett, Powell, OH (US); Keith A. Overton, Columbus, OH (US); William E. Stimel, Alexandria, OH (US)

(73) Assignee: CVG MANAGEMENT CORPORATION, New Albany, OH (US)

(21) Appl. No.: 13/224,017

(22) Filed: Sep. 1, 2011

Related U.S. Application Data
(60) Provisional application No. 61/379,955, filed on Sep. 3, 2010.

(51) Int. Cl. H02P 9/04; F03D 9/02

(52) U.S. Cl. 290/44; 290/55

(57) ABSTRACT

Systems and methods of capturing and channeling air through a wind turbine mounted atop a truck (or vehicle roof) are disclosed. The air can be channeled through a specially designed truck roof into an inlet of a wind turbine. In other aspects, ductwork can be used to channel and direct air captured while the truck is in motion. The wind turbine can be a traditional propeller-based turbine. In other aspects, air foil technologies can be employed to increase air flow to and through a turbine.

### CROSS-REFERENCE TO RELATED APPLICATIONS

This application claims the benefit of U.S. Provisional Patent application Ser. No. 61/379,955 entitled “VEHICLE WIND TURBINE” and filed Sep. 3, 2010. The entirety of the above-noted application is incorporated by reference herein.

### BACKGROUND

With today's emphasis on renewable and green energies, wind turbines have become more and more popular in “wind farms.” A wind turbine is essentially a rotary device that extracts energy from wind power. In traditional applications, where the mechanical energy is used directly by machinery, e.g., for pumping water and cutting lumber, the machine is called often referred to as a windmill. On the other hand, if the mechanical energy is converted to electricity, the machine is most often referred to as a generator or wind generator. Oftentimes, these generators are also referred to as a wind turbine or wind turbine generator.

In commercial applications, turbines used in wind farms for production of electric power are usually multi- or three-bladed fans mounted atop a 200 to 300 foot tall tower. To maximize efficiency, the units are computer controlled and positioned into the direction of the wind using motors. It is not uncommon for the blades to rotate in excess of 200 miles per hour. Thus, to enhance longevity, braking systems are often used to maintain a desired rotational speed.

In typical scenarios, the blades rotate between approximately 10-22 revolutions per minute. While gear boxes are commonly used to step up the speed of the generator, alternative designs also use direct drive units. As mentioned above, most all turbines are equipped with breaking systems and/or shut-down features to avoid damage at high wind speeds.

Unfortunately, wind turbine systems have not been effectively used in vehicular applications. In particular, turbines and generators have not been used in the trucking industry where constant air flow is somewhat of a byproduct of constant high speed freeway travel.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a wind turbine or generator positioned atop a roof of a vehicle such as a truck cab. As the truck is in motion, this innovation captures and channels air into a wind turbine thereby converting wind into electrical energy. In one aspect, the wind or air flow can be captured under a windshield visor and channeled into a turbine thereby effecting generation of electricity. Other aspects can employ strategically positioned ducts that capture and channel air into the generator.

In operation, the turbine converts the wind into dc (direct current) electricity for use in powering accessories within the cab. Future uses of the energy can be to (fully or partially) power the engine within the truck itself. In aspects, the turbine can include blades (e.g., fans) or propellers as well as optional wind foils (e.g., Dyson™-like foils). The air flow can be regulated with a braking system or other dampening effect including, but not limited to, frictional rotation limits, air flow limits, or the like.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example block diagram of a wind turbine system in accordance with aspects of the innovation.

FIG. 2 illustrates an example truck cab having a turbine-equipped channeled roof in accordance with aspects of the innovation.

FIG. 3 illustrates an example flow chart of procedures that facilitate wind energy conversion in accordance with an aspect of the innovation.

FIG. 4 illustrates an alternative example truck cab having a channeled roof in accordance with aspects of the innovation.

FIG. 5 illustrates an example top view of a turbine-equipped truck in accordance with aspects of the innovation.

FIG. 6 illustrates an example side view of a turbine-equipped truck in accordance with aspects of the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details.

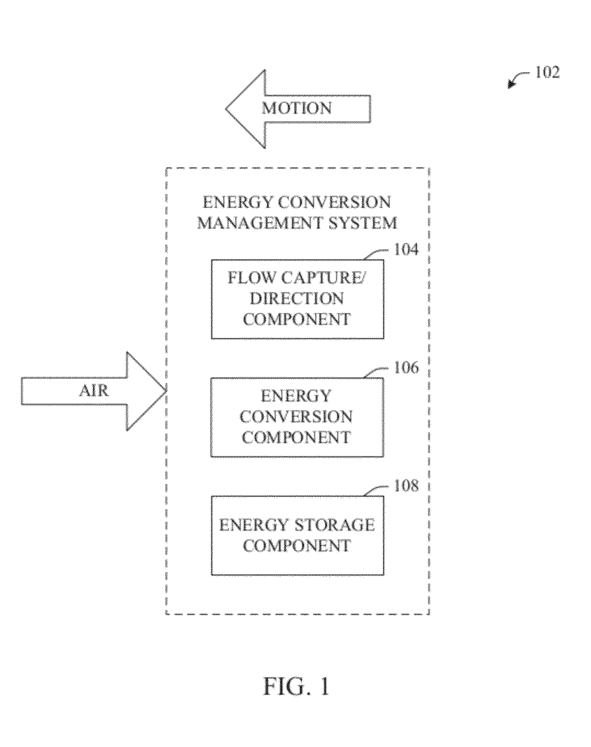

Referring initially to the drawings, FIG. 1 illustrates an example block diagram of an energy conversion management system 102 in accordance with aspects of the innovation. Generally, energy conversion management system 102 can include a flow capture/direction component 104, an energy conversion component 106 and an energy storage component 108. In operation, as a vehicle, e.g., truck, moves in the direction of motion as indicated, the opposing air flow can be captured, converted to electrical energy and stored by components 104, 106 and 108 respectively.

As more and more regulations are imposed upon the trucking industry, it becomes imperative to explore “greener” solutions to powering accessories and amenities within a truck's cab. For example, recent regulations prohibit overnight idle of a truck's engine. Thus, alternative means are desired to power services when the truck's engine is not running. In accordance with the innovation disclosed herein, wind (or air) power can be captured and efficiently converted to DC (direct current) power. This power can be used as generated or stored in a series of batteries and used later to power services (e.g., air conditioning, heating, television, lights) while the truck is not running.

As will be described in greater detail infra, the flow capture/direction component 104 can include a molded roof having an integral channel(s) that directs air into and through a wind turbine. Other aspects can employ ducts that channel air to and through the wind turbine. In most all aspects, the flow capture/direction component 104 can include mechanical and/or computer controlled air regulators such that air volume through the wind turbine can be regulated. Similarly, these regulation mechanisms can control the revolution speed of the fans within a turbine thereby alleviating potential damage. For example, mechanical and/or motor-operated louvers can be employed to regulate air flow into and through a turbine or generator. It will be appreciated that the regulation can be based on most any desired factor, including but not limited to, amount of air, amount of power desired, amount of power storage space available, etc.

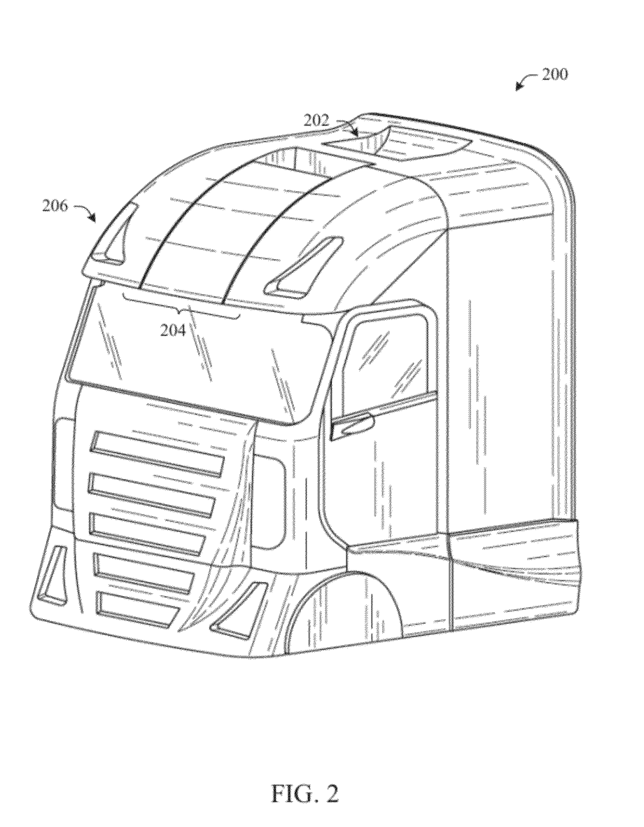

FIG. 2 illustrates an example truck body 200 having a wind turbine 202 positioned or mounted within a cab roof 204. While a specific location of wind turbine is shown in FIG. 1, it is to be understood that alternative aspects employ alternative locations without departing from the spirit and/or scope of the innovation. These alternative aspects are to be included within the scope of this disclosure and claims appended hereto.

In operation, as the truck is in motion, air is channeled into the turbine thereby effecting generation of electricity, e.g., DC (direct current) electricity. For instance, the generated power can be stored in a battery, or plurality of batteries for use in powering accessories or the like. In other aspects, the electricity can be harvested and used to power the vehicle's (truck's) engine.

With today's focus on fuel efficiencies, aerodynamic roofs are common in the trucking industry. However, traditional roofs merely direct air up and over a trailer so as to reduce drag on the truck. This reduction in wind drag can increase fuel efficiencies thereby reducing costs and contributing to the overall focus on greener energies.

The innovation can employ a unique and novel air channeling system that directs some air over the roof while a portion of air is directed into, and through, a wind turbine 202. In one aspect, as shown, the roof can be manufactured or molded with a center channel 204 that captures and/or directs air to the wind turbine 202. The wind turbine can be positioned within the path of the channeled air, for example, in the center of the roof or near the rear of the roof as shown.

In aspects, air can be captured from under a windshield visor and subsequently channeled into and through the wind turbine (via channel 204). It will be appreciated that most any channels or ducts (e.g., 206) can be employed to direct the air. In some aspects the ducts can employ baffles and/or reliefs (not shown) that regulate or restrict air flow as a function of a desired flow rate. In other aspects, throttles or multipliers (not shown) can be employed to increase air pressure thereby effecting efficient (or consistent) generation as lower speeds.

It is to be appreciated that, while the aspect shown in FIG. 2 illustrates a single turbine propeller inlet, other aspects employ multiple inlets without departing from the spirit and/or scope of the innovation. In yet other aspects (not shown), the wind turbine inlet is not externally visible. Rather, the turbine can be mounted under a skin or roof portion. In these aspects, the air can be channeled within interior or integral ducts rather than externally across the roof as shown.

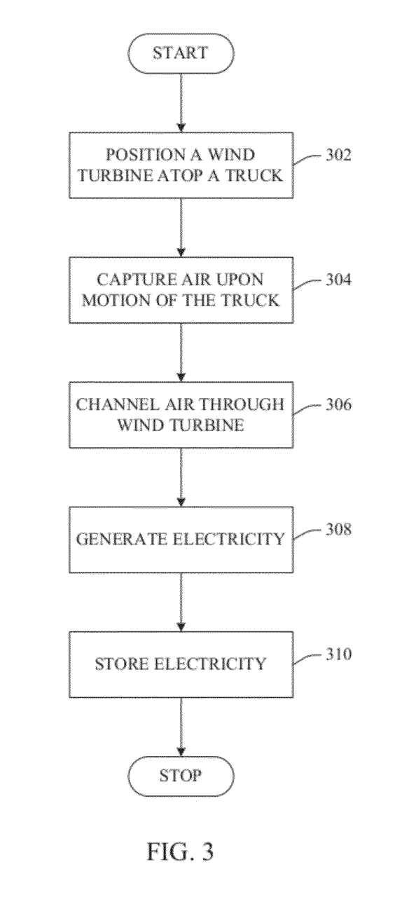

FIG. 3 illustrates a methodology of generating electricity atop a truck's roof in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 302, a wind turbine can be positioned atop a truck roof. As described herein, the turbine can be employed in conjunction with a specially designed roof assembly. The roof assembly can be molded or otherwise configured with strategically positioned channels and/or ducts that capture and direct air into a wind turbine (e.g., as shown in FIG. 2).

Air can be captured at 304 upon motion of the truck (or vehicle). Here, air can be dampened or diverted so as to control or regulate pressure upon the turbine. In other aspects, air can be throttled or multiplied to increase pressure and ultimately flow through the turbine. It will be appreciated that many wind turbines can be damaged by excess wind pressures. For at least this reason, air flow can be regulated via mechanical or computer-controlled means so as to reduce potential damage to the generator(s).

Additionally, regulation of air flow can establish an even or steady flow and subsequent even or steady generation of electricity. It will be appreciated that efficiency of the turbine can be enhanced by throttling up air pressure. In aspects, ductwork can be employed to throttle up or increase flow. In yet other aspects, wind foil technologies can be employed to enhance or increase air flow. In either of these examples, it will be appreciated that, by increasing flow, a comparable amount of electricity can be established at slower speeds as well as higher speeds.

Returning to the methodology of FIG. 3, at 306, air can be directed or channeled through the wind turbine. As described herein, a channeled roof section can be employed to capture and direct air to the turbine. In other aspects, a windshield visor duct assembly can be employed to capture and subsequently direct air to the turbine. Still further, ductwork, tubes or the like can be employed to channel air to the turbine. For example, air can be captured from locations other than (or in addition to) the roof and passed or directed through the turbine. For instance, in a particular aspect, air can be captured via grill louvers located on the front of the vehicle and directed into the turbine.

As the air travels through the turbine, electricity is generated at 308. Those skilled in the art will appreciate wind turbine technologies and specifically the process of converting wind (or air) into electricity. The electricity is stored at 310, for example in batteries. In examples, batteries can be stored within the truck's cab. In other examples, batteries can be stored within the floor of a trailer and electrically connected to the cab and ultimately the wind turbine. It will be understood that, the batteries can be stored in most any location within the cab and/or trailer without departing from the spirit and/or scope of the innovation. Similarly, most any types of batteries can be employed including, but not limited to Li-Ion (Lithium Ion) battery technologies.

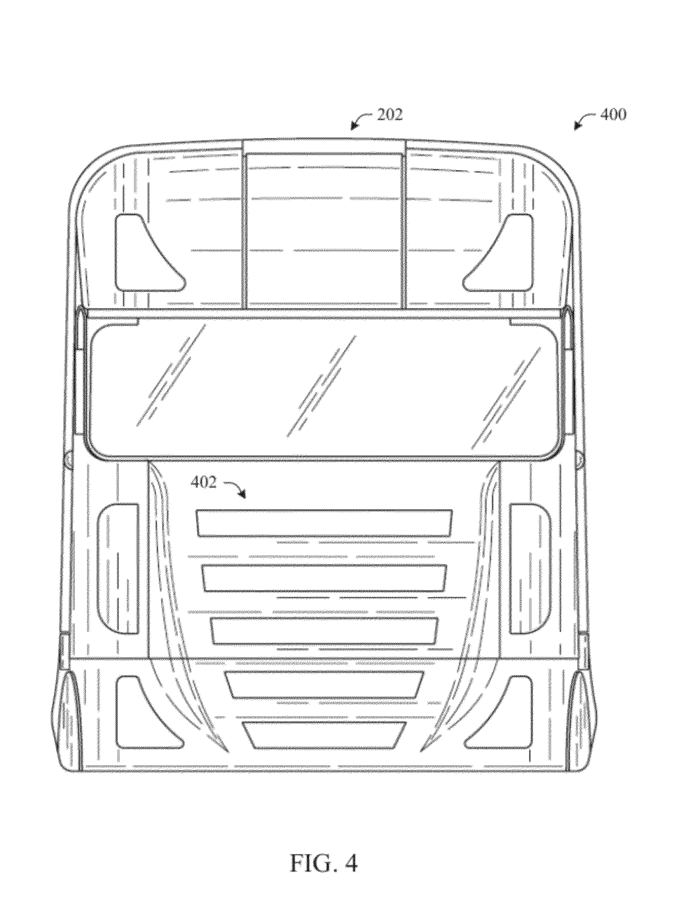

FIG. 4 illustrates yet another aspect of a wind turbine system 400 in accordance with the innovation. As illustrated, FIG. 4 depicts that an integral turbine system can be employs, as shown in FIG. 2; however, the turbine is still externally exposed. While fans or propellers are described herein as a mechanism by which the turbine operates, it is to be understood that other aspects can employ most any turbine technology without departing from the features, functions and benefits of the innovation.

In alternative aspects, wind foil technologies can be employed to multiply or increase air flowing into the turbine. Here, air can be captured and channeled within a wind foil system which, by design, increases air flow output. An example of air foil technology would the Dyson Air Multiplier™ bladeless fan system. In commercial air cooling fan technologies, air foils are advertised to increase or amplify air on the order of 15 to 18 times. A variation of this technology can be incorporated into the subject innovation thereby providing consistent air flow across a broader range of vehicle speeds.

It will be understood that control mechanisms (mechanical and computer operated) can be employed to restrict or otherwise regulate air flow. This regulation can alleviate damage to the turbine which could be caused by high air pressures.

It will be understood that the roof section can be molded of plastic or composite material. Similarly, other suitably rigid materials can be employed without departing from the innovation described herein. In yet other aspects, the roof can be constructed of multiple pieces, sections or components.

In yet other aspects, the truck's louvers 402 (or subset of the louvers 402) can be equipped with mechanical closure mechanisms that open and close as desired or appropriate. For instance, in some aspects, the louvers 402 can open and/or close based upon speed of the truck. In doing so, the aerodynamic profile of the truck can be changed such that more (or less) air can flow up and over the roof of the cab. Thus, the mechanically operated louver system 402 can be integrated into the wind turbine system. In another example, the louvers 402 can be opened or closed (or partially open/closed) at a set mph (miles per hour) speed thereby forcing more (or less) air into the roof channel and ultimately the wind turbine. Still further, the louvers 402 (or subset thereof) can be connected to ductwork that channels air to the wind turbine 202 thereby, facilitating generation of energy.

In other aspects, if desired, the louvers 402 can be opened and/or closed based upon external ambient temperature. Similarly, the louvers 402 can be opened and/or closed based upon engine operating temperature. It will be appreciated that most any mechanical and/or computer-controlled operation mechanisms can be employed to open (or close) the louvers 402 as appropriate or desired. It is to be understood that the louvers 402 can be opened and/or closed using purely mechanical and/or motorized means (including combinations thereof).

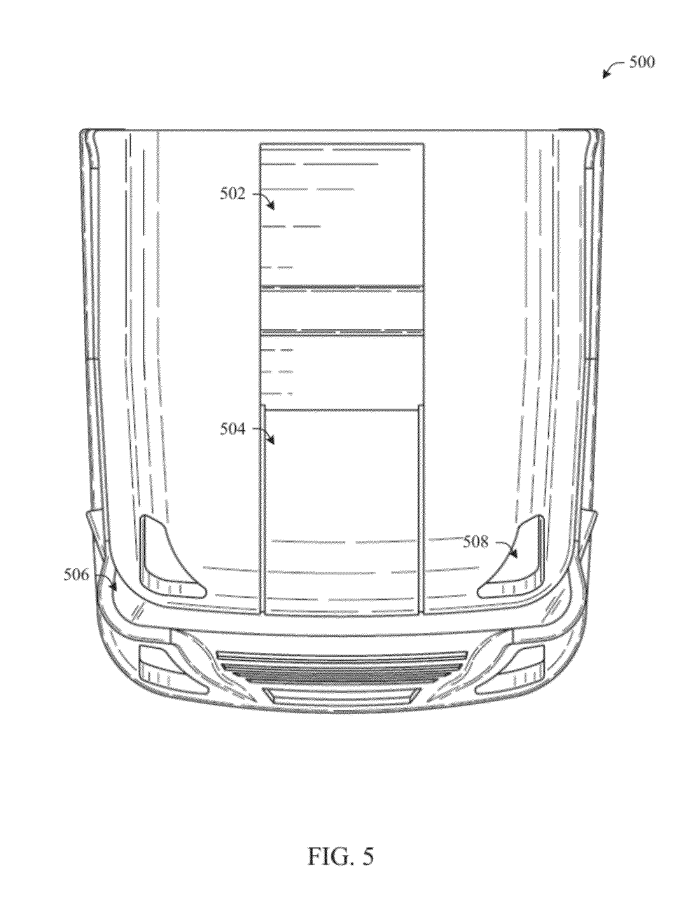

Referring now to FIG. 5, a top view of an example truck roof 500 is shown. As described herein, the truck roof can be equipped with a turbine or generator 502 capable of generating power, e.g., when the vehicle is in motion. Here, a channel 504 can be employed that directs wind or air into the turbine 502. It is to be understood that the channel can be exposed (e.g., indentation in the roof) or otherwise hidden. In the hidden aspect, air can be captured via ductwork or vents such as from under a windshield visor 506 or the like. Further, vents or cutouts 506 can be employed to capture air upon motion of the vehicle. As described above, restrictors, baffles, throttles, maximizers or the like can be employed to regulate air flow into turbine 502.

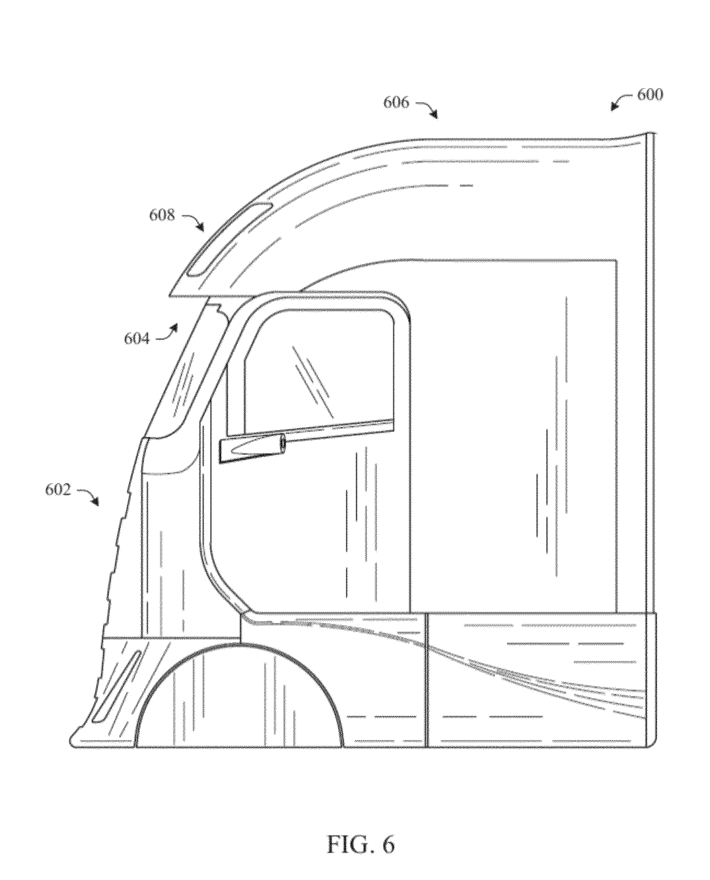

FIG. 6 illustrates yet another example aspect of a turbine-equipped long haul truck in accordance with the innovation. A side view 600 is illustrated showing the position of some key features of the innovation. Operable louvers 602 are shown at the front of the cab 600—as described supra, these louvers 602 can be manually or automatically operated so as to open and close to allow or block air. In one aspect, blocking air will force more air under the visor 604 and into the turbine 606. As will be understood, the turbine 606 of the example of FIG. 6 is hidden and not open to view. In other aspects, the louvers 602 can enable air to travel through ducts (not shown) and into the turbine 606. Thus, when opened, air can be channeled to effect power generation. Further, air can be captured under visor 604 or in duct cutouts 608 so as to effect power generation. As previously discussed, aspects can employ regulation mechanisms capable of decreasing (or increasing) air flow as appropriate or desired.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates conversion of wind energy to electricity in a truck, comprising:
a flow capture component that collects air that flows through a truck roof when the truck is in motion; and
an energy conversion component that receives a subset of the air captured atop the truck roof and converts the subset of the air into electrical energy, wherein the subset of the air is selectively channeled through the energy conversion component.

2. The system of claim 1, wherein the electrical energy facilitates power to a plurality of amenities.

3. The system of claim 1, further comprising an energy store component that retains a subset of the electrical energy in a plurality of batteries.

4. The system of claim 3, wherein the plurality of batteries are Li-Ion batteries.

5. The system of claim 3, wherein a subset of the plurality of batteries are stored within a trailer floor area.

6. The system of claim 3, wherein a subset of the plurality of batteries are stored within a cab floor area.

7. The system of claim 1, wherein the energy conversion component is a propeller-based turbine system.

8. The system of claim 1, wherein the energy conversion component includes a wind foil component that increases air flow through a turbine component.

9. The system of claim 1, wherein the flow capture component includes a molded roof structure having a defined center-channel that directs air through a wind turbine.

10. The system of claim 9, wherein the molded roof is one of a composite or plastic roof structure.

11. The system of claim 1, further comprising a louver system that employs at least one of mechanical or motorized operation to one of open or close one or more of the louvers positioned on a front end of a truck cab.

12. The system of claim 11, wherein the louver system, when closed, enhances direction of air into a wind turbine.

13. The system of claim 11, wherein the louver system when open, allows air into a duct that channels a subset of the air into a wind turbine.

14. The system of claim 1, further comprising a visor assembly that facilitates air to enter a wind turbine.

15. A method of generating DC (direct current) electricity, comprising:
providing a wind turbine on a vehicle;
capturing air upon motion of the vehicle; and
channeling a subset of the air to the wind turbine, wherein the wind turbine generates the DC electricity.

16. The method of claim 15, further comprising regulating one of velocity or amount of the air that is channeled to the wind turbine.

17. The method of claim 16, wherein the act of regulating includes reducing one of velocity or amount of the air.

18. The method of claim 16, wherein the act of regulating includes increasing one of velocity or amount of the air.

19. A system of generating DC electricity, comprising:
means for capturing air upon motion of vehicle;
means for channeling the air to a wind turbine that is mounted within a roof hood of a long haul truck, wherein the wind turbine generates the DC electricity based upon an amount of air; and
means for storing the DC electricity.

20. The method of claim 19, further comprising means for regulating the amount of air to the wind turbine.
